(19) United States
(12) Patent Application Publication
(10) Pub. No.: US 2003/0210780 A1
(43) Pub. Date: Nov. 13, 2003

(54) Device housing having one or more optical fibers

(76) Inventors: Steven Duane Pratt, Ft. Lauderdale, FL (US); Robert W. Pennisi, Boca Raton, FL (US); Fadia Nounou, Plantation, FL (US); Ronald James Kelley, Coral Springs, FL (US); Sivakumar Muthuswamy, Plantation, FL (US)

Correspondence Address: Randi L. Dulaney, Motorola, Inc., Law Department, 8000 West Sunrise Boulevard, Fort Lauderdale, FL, 33322, US

(21) Appl. No.: 10/143,656

(22) Filed: May 10, 2002

(51) Int. Cl. H04M 1/00; H04M 9/00

(52) U.S. Cl. 379/428.01

(57) ABSTRACT

A device housing (20) for a portable electronic device (10) includes an outer visible surface (30). At least one portion (35) of the outer visible surface (30) is composed of one or more optical fibers (40). The one or more optical fibers (40) are illuminated using a light source coupled to at least one end of the one or more optical fibers (40) to provide decorative characteristics and operational functions.

### BACKGROUND OF THE INVENTION

1. Field of the Invention

This invention relates in general to device housings and in particular to device housings having one or more optical fibers contained within for visual alerts and appearance transformations.

2. Description of the Related Art

Housings for portable electronic devices are well known in the art. The role of a device housing in a portable electronic device primarily includes covering, protecting and supporting the internal components encased within. The housing is adapted to provide a particular appearance by means of its molded contour, texture, or color. Typically, a conventional housing of a portable electronic device is standard in appearance and configuration. Minimal variation has conventionally been possible. Conventional portable electronic devices provide limited options for a device user to alter the appearance of the portable electronic device once manufactured. Accessories such as device cases do provide some appearance differentiation, however, they tend to add size and weight to the portable device while providing a limited effect on the overall appearance.

Furthermore, many portable electronic devices provide various alerts to a device user such as message receipt alerts and alarm clock alerts. These alerts can include an audible alert such as a beep or a melody, a silent alert such as a vibration, or a visual alert such as the activation of the subscriber unit's display or the strobing of an LED (light emitting diode). The alerts available to the end user are typically pre-programmed by the manufacturer and stored in the portable electronic device. Some portable electronic devices today also provide for device user manual programming of alerts. Conventional visual alerts include illumination of an LED or lamp individually or in conjunction with a control button and/or visual display. The additional components required in conventional visual alerting schemes add cost and manufacturing time and increases the size of the portable electronic device.

### BRIEF DESCRIPTION OF THE DRAWINGS

The present invention will be described by way of exemplary embodiments, but not limitations, illustrated in the accompanying drawings in which like references denote similar elements, and in which:

FIGS. 1 and 2 are illustrations of a portable electronic device in accordance with the preferred embodiment of the present invention;

FIG. 3 is an exploded view of the portable electronic device of FIGS. 1 and 2 in accordance with a preferred embodiment of the present invention; and

FIG. 4 is a cross sectional view of a device housing for use in the portable electronic device of FIGS. 1-3 in accordance with one embodiment of the present invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

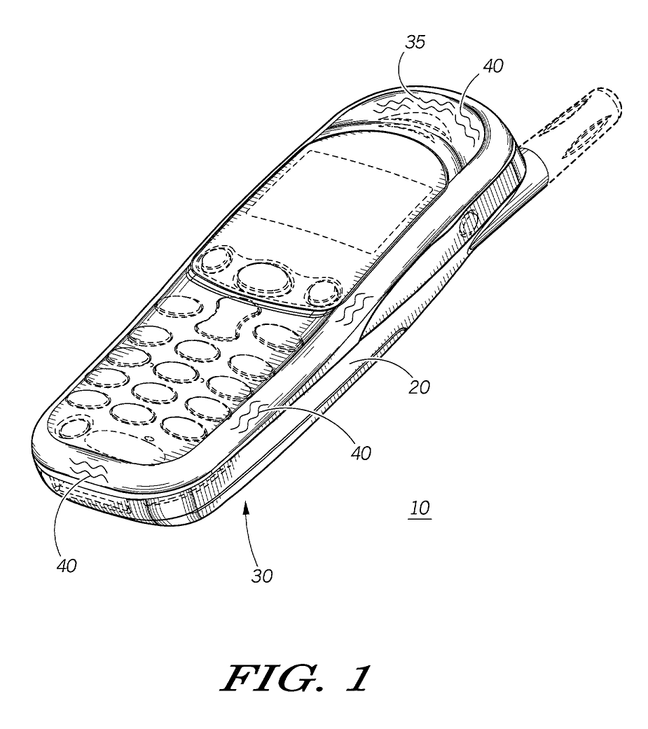

Referring to FIG. 1, a portable electronic device 10 is illustrated. The portable electronic device 10 includes a device housing 20 having an outer visible surface 30. The device housing 20 is preferably manufactured by a plastic injection molding technique as is well known in the art. By way of example, the preferred embodiment of the present invention is described in relation to a fixed housing such as the housing 20 of FIG. 1; however, it will be appreciated by one of ordinary skill in the art that the present invention is similarly applicable to a removable housing accessory such as the removable faceplate described in U.S. Pat. No. 5,884,772, issued Mar. 23, 1999 to Floyd et al. and titled “Electronic Device Having Multiple User Interface Configurations” which is assigned to the assignee of the present invention, and which is incorporated by reference herein. Similarly, the present invention is equally applicable to interchangeable covers for housings such as described in U.S. Pat. No. 5,745,566, issued Apr. 28, 1998 to Petrella et al. and titled “Portable Communication Device Having Removable Escutcheon Elements” which is assigned to the assignee of the present invention, and which is incorporated by reference herein.

Preferably, in accordance with the present invention, at least one portion 35 of the outer visible surface 30 is composed of one or more optical fibers 40. It will be appreciated by those of ordinary skill in the art that the one or more optical fibers 40 can be colored optical fibers, clear optical fibers, and/or any combination therewith. The one or more optical fibers 40 can, for example, consist of an inner plastic core coated with a fluorinated polymer. Alternatively, the one or more optical fibers 40 can consist of a polystyrene core coated with a Polymethyl Methacrylate. The one or more optical fibers 40 further can consist of a solid core, Teflon-clad, flexible optical light cable. The one or more optical fibers 40 can also consist of a germanium doped core and a silica cladding. Further, the one or more optical fibers 40 can be constructed to provide a scintillation effect. It will be appreciated by those of ordinary skill in the art that the one or more optical fibers 40 can consist of any of the cores and coating combinations mentioned herein or an equivalent. The one or more optical fibers 40 can comprise a variety of sizes and lengths without deviating from the intent of the invention. The one or more optical fibers 40 can be illuminated using a light source coupled to at least one end of the one or more optical fibers 40. The light emitted through the one or more optical fibers 40 then can travel at a predetermined wavelength(s) to maximize diffusion of the light source. The integration of the one or more optical fibers 40 into the device housing 20 can, for example, provide a “neon light” effect decoration.

The one or more optical fibers 40 are preferably insert molded into the plastic of the device housing 20 during the manufacturing of the device housing 20. For example, the one or more optical fibers 40 can be fixed in a desired geometry between two in-mold films prior to the manufacturer performing traditional in-mold film injection molding to create the device housing 20. It will be appreciated by those of ordinary skill in the art that the one or more optical fibers 40 can comprise a variety of sizes, lengths and shapes, and have an orientation, a layout, or an equivalent predetermined visual effect. Further, it will be appreciated by those of ordinary skill in the art that the one or more optical fibers 40 can be used in combination with other decoration technology on the device housing 20, such as graphics on the in-mold film, laser etching, electrochromic paint, thermochromic paint, electroluminescent panels, selective masking, and the like to produce desirable decorative effects. The one or more optical fibers 40 can further be used in combination with a multipurpose lightpipe to provide both decorative and functional effects.

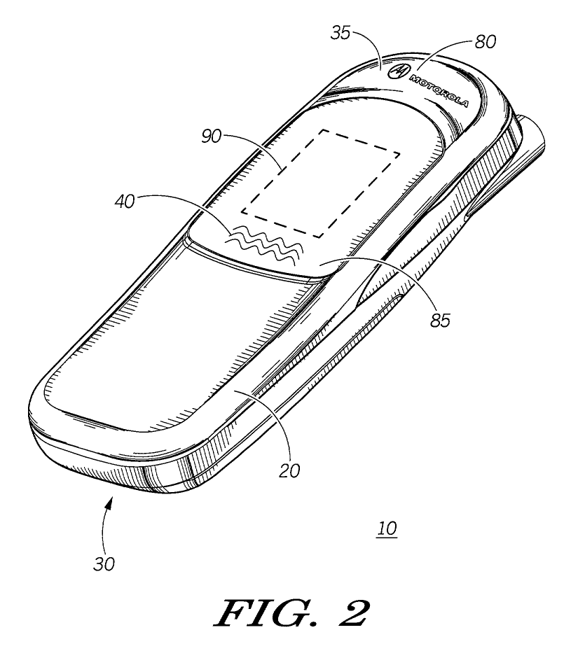

FIG. 2 is an illustration of one embodiment of the portable electronic device 10 of FIG. 1 in accordance with a preferred embodiment of the present invention. As illustrated in FIG. 2, the at least one portion 35 comprising the one or more optical fibers 40 of the outer visible surface 30 of the device housing 20 can include a shape element 80. The shape element 80, for example, can be a manufacturer's identification, an identification data, an identification code, an identification pattern, an identification image, or any combination therein. Alternatively, the shape element 80 including the one or more optical fibers 40 can be used to highlight a second portion 85 of the device housing 20. The shape element 80 including the one or more optical fibers 40 can further be used to highlight an element of the portable electronic device 10, for example, directing the device user to look at a display 90 when a message has arrived.

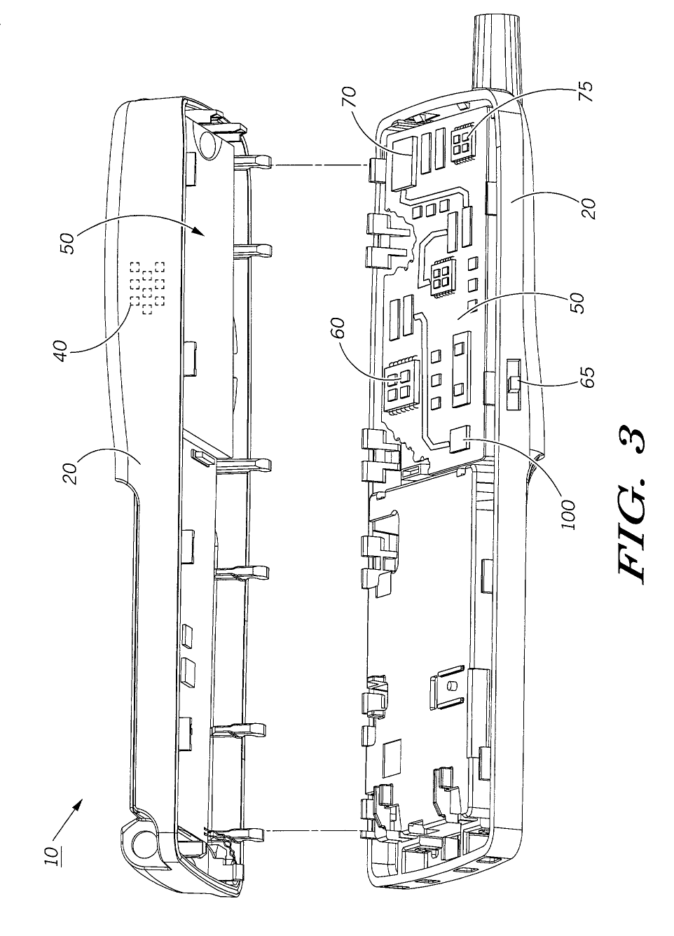

FIG. 3 is an exploded view of the portable electronic device 10 of FIGS. 1 and 2 in accordance with a preferred embodiment of the present invention. As illustrated in FIG. 3, the portable electronic device 10 includes a plurality of internal components 50. The device housing 20 encases the plurality of internal components 50, providing covering, protection and structural support. Preferably, and in accordance with the present invention, the plurality of internal components 50 includes a light generating circuit 60. It will be appreciated by those of ordinary skill in the art that the light generating circuit 60 can include an LED, a lamp, or an equivalent. The light generating circuit 60 passes light through the one or more optical fibers 40. Preferably, one end of each optical fiber is connected to the light generating circuit 60. When the light generating circuit 60 is activated, the one or more optical fibers 40 produce a visual indication visible on the outer visible surface 30 of the device housing 10. For example, the visual indication can be a glow similar to a neon light. The visual indication can be one or more colors, clear illumination, and/or a combination therewith.

In one embodiment, the sensitivity of the visual indication of the one or more optical fibers 40 can be adjusted or turned on or off. For example, the portable electronic device 10 can include manual sensitivity switches 65 or software algorithms (not shown) to allow the device user to adjust the sensitivity of the visual indication as desired. Further, in accordance with the present invention, the visual indication can be dynamically controlled either by a processor 75 within the plurality of internal components 50 of the portable electronic device 10, a computer external to the portable electronic device 10, via receipt of a communication message either wirelessly or through a wired line, or any combination or equivalent therein. Dynamically controlling the visual indication provides a method for animations, messages, user customizable looks, and the like.

In one embodiment of the present invention, the plurality of internal components 50 includes an alert generating circuit 70. The alert generating circuit 70 can be used to notify a device user of receipt of a new message, of an incoming message or call, of a particular alarm time, or the like. In accordance with the present invention, the one or more optical fibers 40 produce a visual indication in response to a signal from the alert circuit 70. It will be appreciated by those of ordinary skill in the art that the alert circuit 70 can generate a signal directly to the one or more optical fibers 40. Alternatively, the alert circuit 70 can generate a signal to the light generating circuit 60 causing the light generating circuit 60 to activate and the one or more optical fibers 40 to produce a visual indication visible on the outer visible surface 30 of the device housing 10. The device user can, for example, choose from a menu of pre-stored alerts to change the visual indication when a message was received for different categories of messages, e.g., personal or business messages, and for different message sources, e.g., information services vs. corporate system.

In one embodiment, the plurality of internal components 50 includes an ultraviolet (UV) light producing element 100. When the UV light producing element 100 is activated, the one or more optical fibers 40 produce a visual indication visible on the outer visible surface 30 of the device housing 10. For example, the visual indication can be a glow similar to a neon light. The visual indication can be one or more colors, clear illumination, and/or a combination therewith. When the device housing 20 is further comprised of a fluorescent plastic housing material, the UV light producing element 100 coupled with the one or more optical fibers 40 creates a “glow-in-the-dark” effect of the fluorescent plastic housing material of the device housing 20.

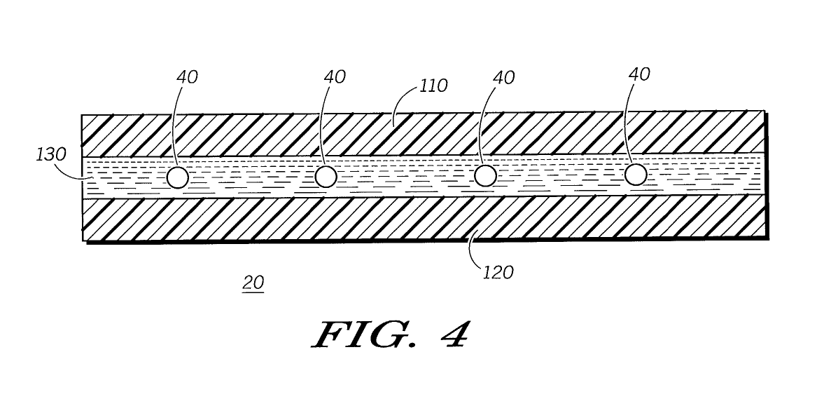

FIG. 4 is a cross sectional view of one embodiment of the device housing 20 for use in the portable electronic device 10 of FIGS. 1-3 in accordance with one embodiment of the present invention. As illustrated, the device housing 20 is composed of an outer layer 110, an inner layer 120, and an enclosed volume 130 arranged between the outer layer 110 and the inner layer 120. The outer layer 110 preferably is composed of a transparent material to provide a visual path to the enclosed volume 130. The outer layer 110 can be composed, for example, of a first plastic film. The inner layer 120 can be either transparent or opaque in accordance with the present invention. The inner layer 120 can be composed, for example of a second plastic film. It will be appreciated by those of ordinary skill in the art that the outer layer 110 and the inner layer 120 can be composed of any combination of the materials mentioned herein or an equivalent.

In one embodiment, the enclosed volume 130 comprises the one or more optical fibers 40. The one or more optical fibers 40 can comprise a variety of sizes and lengths without deviating from the intent of the invention. The one or more optical fibers 40 are illuminated using a light source coupled to at least one end of the light channel. The light emitted from the light source then can travel at a predetermined wavelength(s) to maximize diffusion of the light source. The visual indication produced by the one or more optical fibers 40 can create special effects within the enclosed volume 130 that are then visible through the outer layer 110. In one embodiment, the outer layer 110 is composed of fluorescent material and the one or more optical fibers 40 within the enclosed volume 130 emit a light comprising a frequency causing the outer layer 110 to fluoresce. In an alternate embodiment, the outer layer 110 is composed of photochromic material and the one or more optical fibers 40 within the enclosed volume 130 emit a light, which causes the photochromic material to change color. In a further alternate embodiment (not shown) the outer layer 110 is constructed as a light waveguide and the one or more optical fibers 40 within the enclosed volume 130 emit a light which is channeled through the light waveguide.

The invention as described herein integrates one or more optical fibers into a molded plastic device housing to create both decorative and functional visual effects. Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. A device housing for use in a portable electronic device comprising:
an outer visible surface having:
at least one portion composed of one or more optical fibers.

2. A device housing as recited in claim 1 wherein the one or more optical fibers have an orientation.

3. A device housing as recited in claim 1 wherein the one or more optical fibers have a layout.

4. A device housing as recited in claim 2 wherein the one or more optical fibers include colored optical fibers.

5. A device housing as recited in claim 1 wherein the one or more optical fibers include clear optical fibers.

6. A device housing as recited in claim 1 wherein the at least one portion comprises a shape element.

7. A device housing as recited in claim 6 further comprising a second portion, wherein the shape element including the one or more optical fibers highlights the second portion.

8. A device housing as recited in claim 1 wherein the portable electronic device includes a light generating circuit, and further wherein the light generating circuit passes light through the one or more optical fibers.

9. A device housing as recited in claim 8 wherein the light generating circuit comprises a light emitting diode.

10. A device housing as recited in claim 8 wherein the light generating circuit comprises a lamp.

11. A device housing as recited in claim 1 wherein the one or more optical fibers produce a visual indication and further wherein the visual indication is visible on the outer visible surface.

12. A device housing as recited in claim 11 wherein the visual indication comprises one or more colors.

13. A device housing as recited in claim 12 wherein the visual indication is adjusted using a means selected from the group consisting of a manual sensitivity switch, an internal processor, an external computer, a software algorithm, and a receipt of a communication message.

14. A device housing as recited in claim 1 wherein each of the one or more optical fibers have at least one end, and further wherein the at least one end is coupled to one or more light sources.

15. A device housing as recited in claim 14 wherein the one or more light sources include a light emitting diode.

16. A device housing as recited in claim 1 wherein the portable electronic device includes an alert generating circuit, and further wherein the one or more optical fibers produce a visual indication in response to a signal from the alert generating circuit.

17. A device housing for use in a portable electronic device comprising:
an outer visible surface composed of a fluorescent plastic; and
at least one portion composed of one or more optical fibers,
wherein the one or more optical fibers emit a light comprising a frequency, and further wherein the fluorescent plastic fluoresces in response to the light.

18. A device housing as recited in claim 17 further comprising a second portion, wherein the one or more optical fibers are oriented to direct a user's attention to the second portion.

19. A device housing as recited in claim 17 wherein the portable electronic device includes an alert generating circuit, and further wherein the one or more optical fibers emit the light in response to a signal from the alert generating circuit.

20. A device housing for use in a portable electronic device comprising:
an outer layer, wherein the outer layer is composed of a transparent material;
an inner layer; and
an enclosed volume arranged between the outer layer and the inner layer, wherein the enclosed volume includes one or more optical fibers.

21. A device housing as recited in claim 20 wherein the outer layer comprises a first plastic film and further wherein the inner layer comprises a second plastic film.

22. A device housing as recited in claim 20 wherein the outer layer is composed of a fluorescent plastic, wherein the one or more optical fibers emit a light comprising a frequency, and further wherein the fluorescent plastic fluoresces in response to the light.
